(19) United States
(12) Patent Application Publication
(10) Pub. No.: US 2026/0084550 A1
(43) Pub. Date: Mar. 26, 2026

(54) POWER LINE COMMUNICATIONS TO CONTROL LOCKING AND THERMAL MONITORING FEATURES FOR CHARGING APPLICATIONS

(71) Applicant: Rivian IP Holdings, LLC, Irvine, CA (US)

(72) Inventors: Aashiv Vij, Los Alamito, CA (US); Nicholas Keeling, Irvine, CA (US); Lixiang Wei, Irvine, CA (US)

(21) Appl. No.: 18/896,343

(22) Filed: Sep. 25, 2024

(51) Int. Cl. B60L 53/16; B60L 53/62; H01R 31/06

(52) U.S. Cl. CPC B60L 53/16; B60L 53/62; B60L 2250/16; H01R 31/06

(57) ABSTRACT

A charging dispenser and corresponding method are disclosed. The charging dispenser includes an adapter, a first lock latch that is configured to couple the adapter to a holster of the charging dispenser, a cable coupler electrically coupled to the charging dispenser, and a second lock latch configured to couple the cable coupler to the adapter. The cable coupler is configured to provide power using a first charging standard without the adapter and provide power using a second charging standard when coupled to the adapter. In addition, the adapter may include at least one temperature sensor and an adapter controller to measure temperatures using the temperature sensors and communicate a signal to the charging dispenser through the cable coupler based on the cable coupler based on the measured temperature.

### INTRODUCTION

The present disclosure relates to charging dispensers that provide power using one of a first charging standard or a second charging standard. In some embodiments, the present disclosure relates to locking an adapter to the charging dispenser to provide power using one of the first charging standard or the second charging standard.

### SUMMARY

The present disclosure is directed to charging dispensers, and more particularly to charging dispensers that may provide power using a first charging standard (e.g., North American Charging Standard (NACS)) and a second charging standard (e.g., Combined Charging Standard (CCS)) by using an adapter that is coupled to the cable coupler of the charging dispenser. Such charging dispensers can be used in a charging system to provide power from a utility grid to a vehicle that is electrically coupled to the cable coupler or adapter.

The present disclosure is directed to a charging dispenser that includes a cable coupler electrically coupled to the dispenser that is configured to provide power using the first charging standard (i.e., a native charging standard to the charging dispenser). The charging dispenser also includes an adapter configured to be coupled to the cable coupler, and when the adapter is coupled to the cable coupler, the adapter provides power using the second charging standard.

Adapters for charging dispensers may be misplaced or may be targets of theft as they are useful components to enable vehicles that are not compatible with the first charging standard (i.e., the native charging standard), but rather use the second charging standard, to charge. The present disclosure in accordance with some embodiments is directed to charging dispensers with an adapter, a holster, a first lock latch configured to couple the holster to the adapter, a cable coupler that is electrically coupled to the dispenser and configured to provide power, and a second lock latch configured to couple the cable coupler to the adapter. The cable coupler is configured to provide power using the first charging standard without the use of the adapter and provide power using the second charging standard when coupled to the adapter. The use of the first lock latch and the second lock latch ensures that the adapter is either locked to the holster of the charging dispenser when not being used or locked to the cable coupler when being used to provide power using the second charging standard.

According to the present disclosure, the adapter may include an adapter controller to communicate with the charging dispenser. In some embodiments the charging dispenser includes a dispenser controller that is communicatively coupled to the adapter controller using a local interconnect network (LIN). In some embodiments, the dispenser controller is communicatively coupled to each of the first lock latch and the adapter controller, and the adapter controller is communicatively coupled to the second lock latch. The dispenser controller may receive a signal (e.g., from a user interface displayed on a display of the charging dispenser or from a user device) that indicates whether the charging dispenser is to provide power using the first charging standard or provide power using the second charging standard. Power provided using the first charging standard may be the same power provided using the first charging standard. For example, when the dispenser controller receives a signal that indicates the charging dispenser is to provide one of the first charging standard or the second charging standard, the charging dispenser will provide a same DC power, using either the first charging standard or the second charging standard, respectively, based on the received signal. In some implementations, the first charging standard may differ from the second charging standard in their respective charging coupler form factor, and therefore their charging port form factor, as well as communication protocols over their respective communication wires. In some implementations, the first charging standard and the second charging standard may use at least one of the same communication wires. When the signal indicates that the charging dispenser is to provide power using the first charging standard the dispenser controller causes to lock the first lock latch and causes to unlock the second lock latch, such that the adapter is locked to the holster and the cable coupler may be uncoupled from the adapter to charge a device (e.g., user's vehicle) using the first charging standard. When the signal indicates that the charging dispenser is to provide power using the second charging standard the dispenser controller causes to unlock the first lock latch, and causes to lock the second lock latch, such that the adapter may be uncoupled from the holster and the adapter is electrically coupled to the cable coupler to provide power to the device (e.g., user's vehicle) using the second charging standard.

The temperature of charging dispensers and their components (e.g., cable coupler, adapter) may not be actively monitored, and therefore the temperature of a component of the charging dispenser, such as an adapter, may rise past a certain temperature threshold resulting in interruptions and/or failures in power provisioning services. This may increase the charging time for a user of the charging dispenser or possibly render the charging dispenser unusable for the user.

According to some embodiments of the present disclosure, the adapter may include at least one temperature sensor and the adapter controller is configured to measure the temperature using the temperature sensors and communicate a signal to the charging dispenser to tune the power provided through the cable coupler based on the measured temperature. This enables the charging dispenser to actively monitor the temperature of the adapter and the adapter maintains sustainable power provisioning of the charging dispenser to avoid a sharp derating or complete disruption when providing power.

In some embodiments, the charging dispenser includes a dispenser controller that is communicatively coupled to the adapter controller using a local interconnect network (LIN). In some embodiments, the LIN may be implemented using a single wire configured to communicatively couple the dispenser controller and the adapter. The LIN may be any existing communication line that is used for each of the first charging standard and the second charging standard. For example, when the first charging standard is NACS, and the second charging standard is CCS, the proximity line (PL) may act as the LIN between the dispenser controller and the adapter controller. When the adapter is not coupled to the cable coupler, the LIN may be used to monitor voltage within the charging dispenser. When the adapter is coupled to the cable coupler, the LIN is also configured to transmit signals between the adapter controller and the dispenser controller. For example, when the adapter controller measures temperature in the adapter to be above a first temperature threshold, the adapter controller communicates a signal to the dispenser controller, using the LIN, indicating that the power provided through the cable coupler should be tuned based on the measured temperature.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative charging system from an electrical power grid to an electric vehicle (EV), the charging system implemented with a charging dispenser, in accordance with an embodiment of the present disclosure;

FIG. 2 shows an illustrative charging system of the charging dispenser from FIG. 1, the charging dispenser implemented with a first lock latch, a second lock latch, and an adapter, in accordance with an embodiment of the present disclosure;

FIG. 3 shows an illustrative charging system of the charging dispenser from FIG. 1, the charging dispenser implemented with another implementation of an adapter with a temperature sensor, in accordance with an embodiment of the present disclosure;

FIG. 4 shows an illustrative flowchart depicting a process for a charging dispenser to provide power using one of a first charging standard and a second charging standard, in accordance with an embodiment of the present disclosure; and

FIG. 5 shows an illustrative flowchart depicting a process for an adapter controller of the adapter to monitor temperature and communicate with the charging dispenser through the cable coupler, in accordance with an embodiment of the present disclosure.

### DETAILED DESCRIPTION OF DRAWINGS

In some embodiments, the present disclosure is related to a charging system with a charging dispenser that may be configured to provide power to a device (e.g., an electrical vehicle (EV)) using one of a first charging standard (e.g., NACS) and a second charging standard (e.g., CCS). The charging dispenser is configured to receive power from a DC power source (e.g., power cabinet) and provide power, and determine with which of the first charging standard and the second charging standard to provide DC power to the device to be charged (e.g., an EV). The charging dispenser includes a dispenser controller configured to determine whether the charging dispenser is to provide power using the first charging standard or the second charging standard and based on that determination, cause each of the first lock latch and the second lock latch to lock or unlock, to couple or decouple components of the charging system. The charging dispenser also includes a holster that is configured to accept and couple to the charging port of the adapter using a first lock latch. The adapter may be used to convert DC power of a first charging standard (e.g., NACS) received from the cable coupler to DC power of a second charging standard (e.g., CCS) that is provided to the device that is to be charged. For example, the adapter may be a NACS-to-CCS adapter to convert DC power using NACS to DC power using CCS. The charging system further includes a charge cable, which houses a control local interconnect network (LIN) configured to transmit signals between the charging dispenser and the device to be charged, and at least one DC power line to transmit DC power to the device that is to be charged (e.g., an EV) through a cable coupler. When the adapter is electrically coupled to the cable coupler to provide power using the second charging standard the LIN may be used to communicate signals between the adapter controller of the adapter and the dispenser controller of the charging dispenser. In some embodiments, the cable coupler may be electrically coupled to a device (e.g., an EV) that has a charging port compatible with the first charging standard (e.g., NACS) and is charged without the use of the adapter. In such embodiments, the adapter may be coupled to the cable coupler using the second lock latch, and the adapter may then be electrically coupled to a device (e.g., a second EV) that has a charging port compatible with the second charging standard (e.g., CCS).

As discussed throughout, the first charging standard may be the NACS, and the second charging standard may be the CCS. Each of the first charging standard and the second charging standard employ different charging port and terminals/connections designs. Therefore, an adapter may be used to convert power received from the cable coupler, which uses the first charging standard, to power using the second charging standard and providing the converted power through a charging port which is compatible with the second charging standard. The cable coupler, which provides power using the first charging standard (e.g., NACS), may include two power terminals, a ground terminal, a control pilot terminal, and a proximity pilot terminal. Each of the two power terminals, ground terminal, control pilot terminal, and proximity pilot terminal is communicatively coupled to a respective power line, ground signal line, control pilot bus or proximity pilot bus (e.g., the LIN) that is housed by the charge cable and extend from the charging dispenser. In some implementations, the two power terminals of the cable coupler include a positive power terminal that provides positive DC current and a negative power terminal that provides negative DC current. The adapter, which converts power using the first charging standard (e.g., NACS) to power using the second charging standard (e.g., CCS) may also include two power terminals, a ground terminal, a control pilot terminal, and a proximity pilot terminal. Each of the two power terminals, ground terminal, control pilot terminal, and proximity pilot terminal is communicatively coupled to a respective power line, ground signal line, control pilot bus or proximity pilot bus (e.g., the LIN) that is housed by the charge cable and extend from the charging dispenser through the adapter. In some implementations, the two power terminals of the cable coupler include a positive power terminal that provides positive DC current and a negative power terminal that provides negative DC current.

The control pilot terminals and control pilot bus for each of the NACS and the CCS may be used as communication lines for charging states or current signaling of the power transmitted along the power lines. In some implementations, the proximity pilot terminals and proximity pilot bus (e.g., the LIN) may be used as communication lines for charging connector status signaling. For example, the proximity pilot bus may transmit signals indicating whether the cable coupler or adapter is electrically coupled to the device (e.g., an EV) that is to be charged. However, as discussed herein, at least one of the communication lines (e.g., one of proximity pilot bus and the control pilot bus) may be leveraged to transmit lock latch control signals from the charging dispenser or transmit signals from the adapter to the charging dispenser indicating to derate or terminate the charging of a device being charged. Although discussions provided herein include examples of NACS as the first charging standard and CCS as the second charging standard, the first charging standard and the second charging standard may be any suitable charging standards that include shared charging port terminals that may be converted from/to by use of an adapter, and that at least one of those shared port terminals includes at least one communication line (e.g., proximity pilot bus, control pilot bus, or any suitable local interconnect network (LIN) bus).

The present disclosure is also directed to a charging system with an adapter that may further include at least one temperature sensor, and where the adapter controller is configured to measure temperature using the temperature sensors and communicate a signal to the charging dispenser through the cable coupler (e.g., using LIN) based on the measured temperature. The measured temperature may cause the adapter controller to communicate a signal indicating that the charging dispenser is to derate the charging rate of the power provided to the device or is to terminate power provisioning to the device.

The dispenser controller of the charging dispenser may receive the signal from the adapter controller and determine to derate the power provided through the charge cable or terminate the charging altogether. For example, the adapter controller may communicate a first signal indicating a first measured temperature within the adapter. In such an example, the dispenser controller may determine that the first measured temperature is greater than a first temperature threshold and based on that determination, cause to derate the charging to a corresponding charging rate (e.g., 90% of the normal charging rate). The adapter controller may then communicate a second signal indicating a second measured temperature within the adapter where the second measured temperature is greater than the first measured temperature. When the dispenser controller receives the second signal, the dispenser controller may determine that the first measured temperature is greater than a second temperature threshold and based on that determination, cause to further derate the charging to a corresponding charging rate (e.g., 75% of the normal charging rate). In another example, the adapter controller may communicate a third signal indicating a third measured temperature within the adapter. The dispenser controller may determine that the third measured temperature is greater than a stopping threshold and based on that determination, cause to terminate the charging of the device. In some implementations, the charging may be terminated by way of an electrical switch and/or thermal switch. In some implementations, the adapter controller may calculate an average temperature by determining an average temperature value based on the measured temperature values of the temperature sensors in the adapter. The adapter controller may then communicate the signal to the charging dispenser through the cable coupler based on the calculated average temperature. The adapter controller may determine a maximum temperature among the measured temperature values from the temperature sensors and communicate the signal to the charging dispenser through the cable coupler based on the determined maximum temperature.

The adapter may include any suitable temperature sensors (e.g., one or more thermocouple, thermistor, resistance temperature detectors (RTDs), or any integrated circuit (IC) temperature sensor). In some implementations, the adapter may also include a thermal switch or fuse for purposes for terminating power provisioning of the charging dispenser to a device. The thermal switch or fuse may be configured to terminate the charging of the device when the temperature in or near the adapter exceeds a thermal switch threshold. The implementation of thermal switches and fuses provides further safety for users which may interface with the charging dispenser to charge the device.

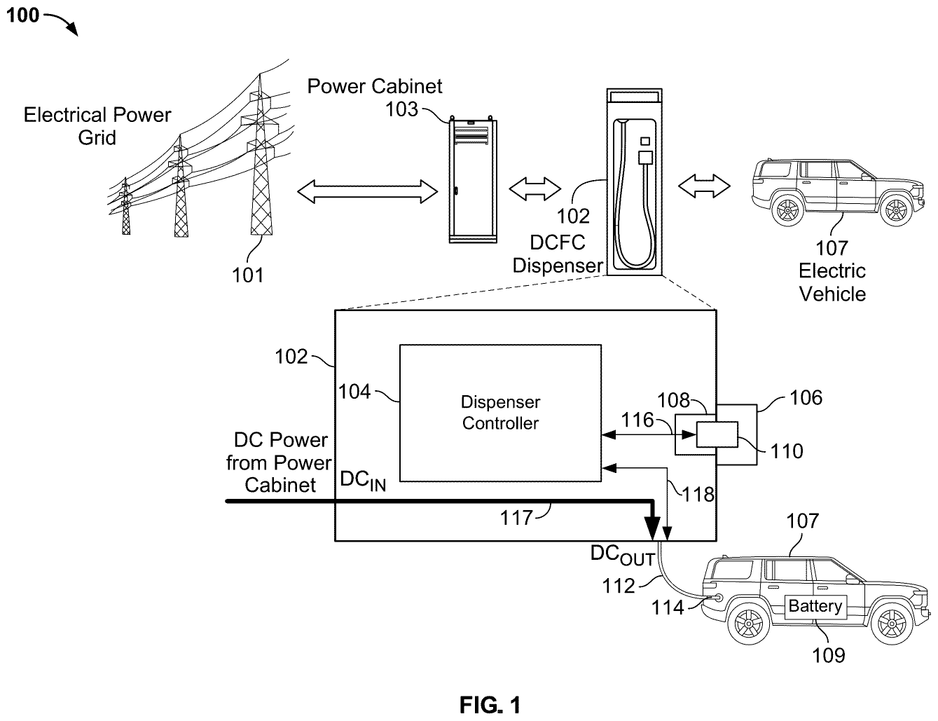

FIG. 1 shows an illustrative system 100 from an electrical power grid 101 to an electric vehicle (EV) 107, the system 100 implemented with a power cabinet 103, and a charging dispenser 102 (e.g., a DC-Fast Charging (DCFC) dispenser) in accordance with an embodiment of the present disclosure. In some embodiments, the power cabinet 103 may be implemented as any suitable device that is configured to transform the alternating current (AC) power received from the electrical power grid 101 to DC power that is provided to the charging dispenser 102. System 100 includes EV 107, charging dispenser 102, power cabinet 103, and electrical power grid 101. Electric vehicle 107 includes rechargeable battery 109. Charging dispenser 102 may provide power to any other device with a rechargeable battery that is compatible with any one of the first charging standard (e.g., NACS) and the second charging standard (e.g., CCS). Charging dispenser 102 includes dispenser controller 104, adapter 106, holster 108, first lock latch 110, second lock latch (not pictured), charge cable 112, cable coupler 114, control signal bus 116, DC power line 117, and LIN 118. In some embodiments, dispenser controller 104 includes memory to store data and/or commands, and at least one processor or processing core to perform commands or processes.

Power cabinet 103 is coupled to electrical power grid 101 via one or more wired electrical power signal paths, by which electrical power grid 101 provides AC electrical power, such as in the form of a three phase 480 volt (V) 60 hertz (Hz) signal, to power cabinet 103. The power cabinet 103 may then convert the AC power received from the electrical power grid 101 into DC power, such as a signal fixed at a voltage in a range from 200 to 920 V and a maximum current of 500 amps (A) at a maximum power of 300 kilowatts (kW). However, this is only one example, as the power cabinet 103 may provide any suitable voltage and current range. In some implementations, the power cabinet 103 includes any suitable AC-DC converter to convert AC power received from electrical power grid 101 to DC power. Although FIG. 1 shows that AC power is sourced from electrical power grid 101, the AC power received by power cabinet 103 may be from any suitable AC power source.

In some embodiments charging dispenser 102 includes a DC/DC converter (e.g., a dual-active bridge convertor (DAB) converter), which converts the DC power received from the power cabinet 103 into an output DC power, which is provided to charge battery 109 via a charging port of EV 107. As described in further detail below, dispenser controller 104, is configured to determine whether cable coupler 114 is to provide DC power using a first charging standard (e.g., NACS) or provide power using a second charging standard (e.g., CCS) and cause to lock or unlock each of the first lock latch 110 and the second lock latch (not pictured in FIG. 1) to couple or decouple components of the charging dispenser to provide power of the determined charging standard (e.g., one of NACS and CCS).

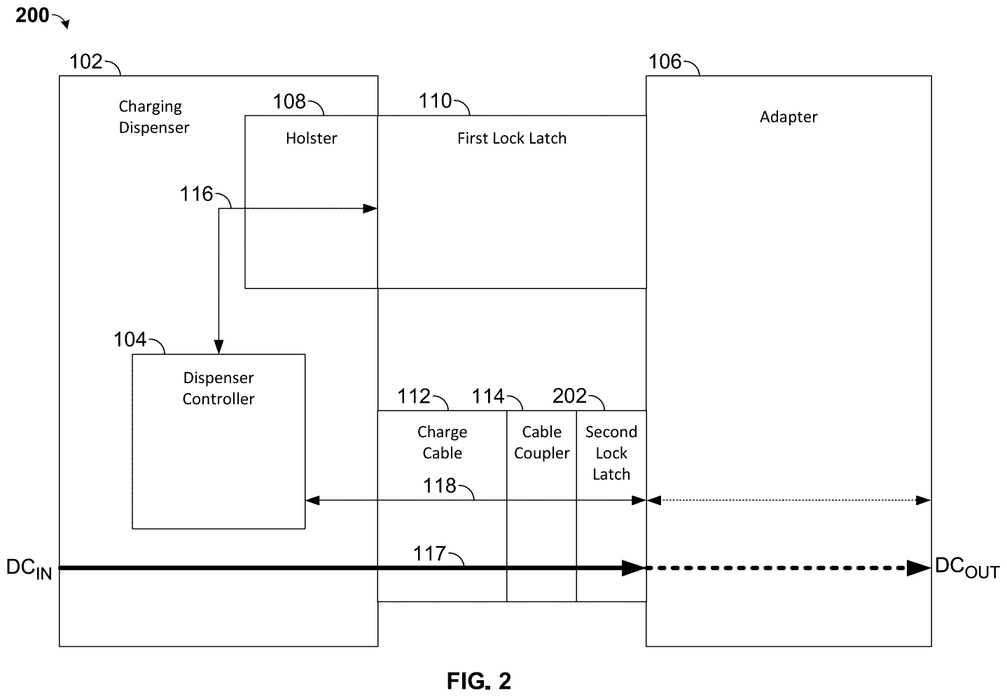

FIG. 2 shows an illustrative charging system 200 which includes charging dispenser 102 of FIG. 1, in accordance with an embodiment of the present disclosure. Charging system 200 includes each component of the charging dispenser 102 as shown in FIG. 1, in addition to second lock latch 202 which is configured to couple the cable coupler 114 to adapter 106. As previously discussed, adapter 106 is configured to convert DC power of a first charging standard (e.g., NACS) received from charging dispenser 102 via the cable coupler 114 to DC power of a second charging standard (e.g., CCS). In some implementations each of the first lock latch 110 and second lock latch 202 uses one or more of a mechanical locking mechanism and an electromagnetic locking mechanism. In some implementations of the charging dispenser 102, each of the first lock latch 110 and the second lock latch 202 comprises a respective motor or other actuator to move a respective locking member into one of a locked position or an unlocked position. In some implementations, the charging dispenser 102 may include a power supply and when the first lock latch 110 is locked, the charging dispenser 102 causes to electrically couple the respective motor of the second lock latch 202 to the power supply. Similarly, when the first lock latch 110 is unlocked and the adapter 106 is removed from the holster 108, the power supply is electrically uncoupled from the respective motor of the second lock latch 202.

When dispenser controller 104 determines that the power that is to be provided to a device uses the first charging standard (e.g., NACS), dispenser controller 104 causes the first lock latch 110 to lock to couple adapter 106 to holster 108 of the charging dispenser 102. The dispenser controller 104 is configured to communicate a control signal, on the control signal bus 116, to the first lock latch 110 indicating that the first lock latch 110 is to lock such that the adapter 106 cannot be removed from the holster 108 while a user is charging a device using the first charging standard (e.g., NACS) with the cable coupler 114. Once the adapter 106 is coupled to the holster 108, the dispenser controller 104 then causes the second lock latch 202 to unlock to decouple the adapter 106 from the cable coupler 114, which is electrically coupled to the charging dispenser 102. The dispenser controller 104 is configured to communicate a control signal, on the LIN 118 of the charge cable 112, to the second lock latch 202 indicating that the second lock latch 202 is to unlock. When the adapter 106 is decoupled from the cable coupler 114, a user may then use the charging dispenser 102 by coupling the cable coupler 114 to a receiving port that is compatible with the first charging standard. The charging dispenser 102 may then provide, by the cable coupler 114, power using the first charging standard.

When dispenser controller 104 determines that the power that is to be provided to a device uses the second charging standard (e.g., CCS), dispenser controller 104 is configured to cause the second lock latch 202 to lock to couple the adapter 106 to the cable coupler 114. The dispenser controller 104 is configured to communicate a control signal, on the on the LIN 118 of the charge cable 112, to the second lock latch 202 indicating that the second lock latch 202 locks to couple the adapter 106 to the cable coupler 114. Once the adapter 106 is coupled to the cable coupler 114, the dispenser controller 104 then causes the first lock latch 110 to unlock such that the adapter 106 may be removed from the holster 108 for a user to charge a device using the second charging standard. The dispenser controller 104 is configured to communicate a control signal, on the control signal bus 116, to the first lock latch 110 indicating that the first lock latch 110 to decouple the adapter 106 from the holster 108. When the adapter 106 is coupled to the cable coupler 114 and the adapter 106 is decoupled from the holster 108, a user may use the charging dispenser 102 by coupling the adapter 106 to a receiving port that is compatible with the second charging standard. The charging dispenser 102 may then provide, by the cable coupler 114 and adapter 106, power using the second charging standard.

In some embodiments, when the adapter is coupled to holster 108 and decoupled from cable coupler 114, the cable coupler 114 may be coupled to a charging port of a device (e.g., an EV) which is capable to receive DC power of the first charging standard (e.g., NACS). In such embodiments, the LIN 118 and DC power line 117 are coupled to corresponding receiving terminals of the charging port of the device (e.g., the EV). In other embodiments, when the adapter 106 is coupled to the cable coupler 114 and decoupled from the holster 108, the adapter 106 may be coupled to a charging port of another device (e.g., a second EV) which is capable to receive DC power using the second charging standard (e.g., CCS).

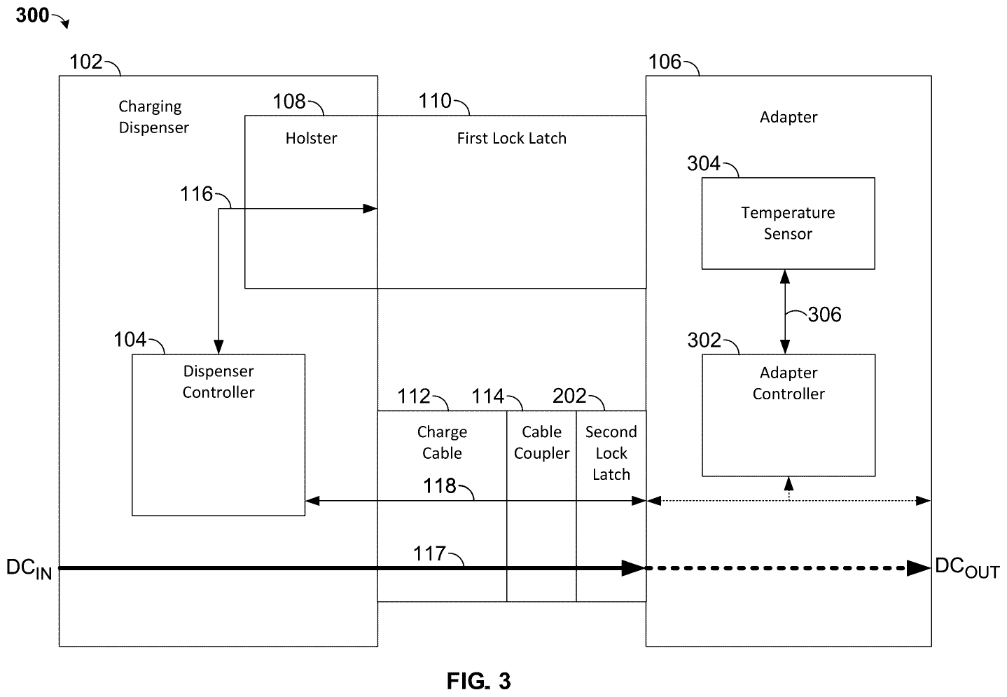

FIG. 3 shows another illustrative charging system 300 which includes charging dispenser 102 of FIG. 2, in accordance with an embodiment of the present disclosure. Charging system 300 includes each component of the charging dispenser 102 as shown in FIG. 2, in addition to adapter controller 302, temperature sensors 304, and temperature signal bus 306, which communicatively couples the temperature sensor 304 to the adapter controller 302. In some embodiments, adapter controller 302 includes memory to store data and/or commands, and at least one processor or processing core to perform commands or processes. Adapter controller 302 is configured to measure temperature using the temperature sensors 304 and communicate a signal to the charging dispenser through the cable coupler 114 (e.g., using LIN 118) based on the measured temperature. The measured temperature may cause the adapter controller 302 to communicate a signal indicating that the charging dispenser 102 should derate the charging rate of the power provided to the device or terminate power provisioning to the device. Adapter 106 may include any suitable temperature sensors 304 (e.g., one or more thermocouple, thermistor, resistance temperature detectors (RTDs), or any integrated circuit (IC) temperature sensor).

In some implementations, the adapter 106 may also include a thermal switch or fuse for purposes of terminating power provisioning of the charging dispenser 102 to a device. The thermal switch or fuse may be configured to terminate the charging of the device when temperature in or near the adapter exceeds a thermal switch threshold. The implementation of thermal switches and fuses provides further safety for users which may interface with the charging dispenser 102 to charge the device.

In embodiments as shown in FIG. 3, when the adapter 106 is being used with the charging dispenser 102 to provide power of the second charging standard, LIN 118 and DC power line 117 are extended through the adapter 106 such that LIN 118 is communicatively coupled to adapter controller 302 and to a corresponding LIN terminal of the charging port of the device (e.g., the second EV), and the DC power line is coupled to a corresponding DC power terminal of the charging port of the device(e.g., the second EV). Therefore, when the adapter 106 is coupled to the cable coupler 114 using the second lock latch 202, the adapter controller 302 is communicatively coupled to the dispenser controller 104 via the LIN 118. As adapter 106 is communicatively coupled to the dispenser controller 104, this enables the adapter 106 to dynamically modify charging rates based on temperatures measured within the adapter 106 by temperature sensors 304, and therefore potentially reducing the number of charging interruptions when charging the device and improving the reliability and longevity of the charging system 300.

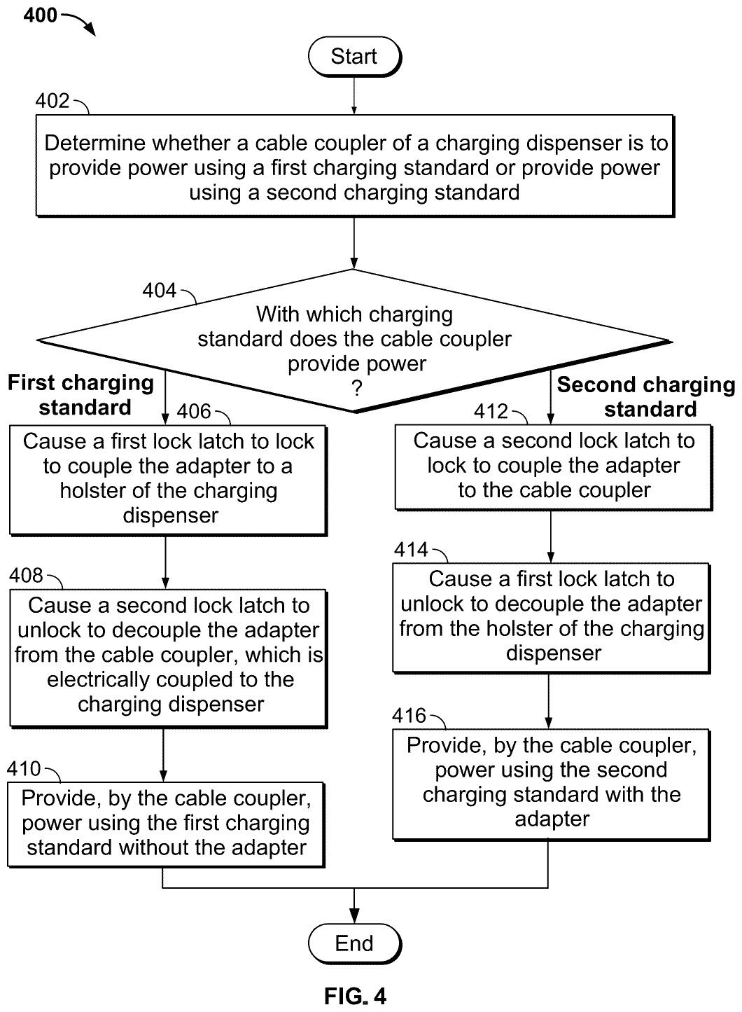

FIG. 4 shows an illustrative flowchart depicting process 400 for a charging dispenser to provide power using one of a first charging standard (NACS) and a second charging standard (CCS), in accordance with an embodiment of the present disclosure. In some embodiments, process 400 is executed on charging dispenser 102 by using adapter controller 302. In some embodiments, referenced charging dispenser, dispenser controller, adapter, holster, first lock latch, charge cable, cable coupler, control signal bus, local interconnect network (LIN), adapter controller, second lock latch, temperature sensor, and temperature signal bus may be implemented as charging dispenser 102, dispenser controller 104, adapter 106, holster 108, first lock latch 110, charge cable 112, cable coupler 114, control signal bus 116, local interconnect network (LIN) 118, adapter controller 302, second lock latch 202, temperature sensor 304, and temperature signal bus 306.

At step 402, the dispenser controller determines whether a cable coupler of a charging dispenser is to provide power using a first charging standard (e.g., NACS) or provide power using a second charging standard (CCS). In some implementations, the dispenser controller makes this determination based on a signal received from a user input or from a user device. In some implementations the charging dispenser includes a user interface configured to receive user input indicative of the charging standard that is to be used for the power provided by the charging dispenser. In some implementations, the charging dispenser includes a communications circuitry that is communicatively coupled to the dispenser controller, where the communications circuitry may be configured to receive signals, such as short-range wireless signals (e.g., radio-frequency (RF) signals, Wi-Fi signals, Bluetooth signals) or long-range wireless signals (e.g., cellular signals or satellite signals), each signal including data indicative of the charging standard that is to be used for the power provided by the charging dispenser. In some embodiments, the wireless signals may be sent by a user device (e.g., a cellular phone, smartphone, key fob, or any other suitable user device that may be communicatively coupled to the communications circuitry of the charging dispenser). In some implementations, the dispenser controller may perform this determination based on a user profile or type of device that is to be charged (e.g., the charging port standard type of the device). For example, the user profile may be accessed by the dispenser controller by way of the communications circuitry (e.g., receiving RF signals), and the dispenser controller determines the type of device to be charged based on the user profile and therefore may determine the charging standard (e.g., one of the first charging standard and the second charging standard) to be used for the charging dispenser when providing power to the device.

At step 404, when the charging dispenser is determined to provide power with the cable coupler using the first charging standard, process 400 proceeds to step 406. When the charging dispenser is determined to provide power with the cable coupler using the second charging standard, process 400 proceeds to step 412.

At step 406, the dispenser controller causes the first lock latch to lock to couple the adapter to the holster of the charging dispenser. The dispenser controller is configured to communicate a control signal, on the control signal bus, to the first lock latch indicating that the first lock latch is to lock such that the adapter cannot be removed from the holster while a user is charging a device using the first charging standard with the cable coupler. In some implementations the first lock latch locks to couple the adapter to the holster of the charging dispenser by using one or more of a mechanical locking mechanism or an electromagnetic locking mechanism. In some implementations of the charging dispenser, each of the first lock latch and the second lock latch comprises a respective motor to move a respective locking member into one of a locked position or an unlocked position. Once the adapter is coupled to the holster, the dispenser controller then causes the second lock latch to unlock to decouple the adapter from the cable coupler, at step 408.

At step 408, the dispenser controller causes the second lock latch to unlock to decouple from the adapter from the cable coupler, which is electrically coupled to the charging dispenser. The dispenser controller is configured to communicate a control signal, on the LIN of the charge cable, to the second lock latch indicating that the second lock latch is to unlock. When the adapter is decoupled from the cable coupler, a user may use the charging dispenser by coupling the cable coupler to a receiving port that is compatible with the first charging standard. In some implementations the second lock latch unlocks to decouple the adapter from the cable coupler of the charging dispenser by using one or more of a mechanical locking mechanism or an electromagnetic locking mechanism. The charging dispenser may then provide, by the cable coupler, power using the first charging standard, at step 410.

At step 410, the charging dispenser provides, by the cable coupler, power using the first charging standard without the adapter. The charging dispenser may provide power by the cable coupler until the power provisioning is terminated by user input or any suitable control signal received from the device being charged. For example, when the device being charged has reached a certain battery charge, the device may communicate a control signal to terminate the power provided from the charging dispenser. In some embodiments, the power provided by the charging dispenser is DC power using a first charging standard (e.g., NACS).

At step 412, when the second charging standard is determined to provide power, the dispenser controller causes the second lock latch to lock to couple the adapter to the cable coupler. The dispenser controller is configured to communicate a control signal, on the LIN of the charge cable, to the second lock latch indicating that the second lock latch locks such that the adapter is coupled to the cable coupler for a user to charge a device using the second charging standard. In some implementations the second lock latch locks to couple the adapter to the cable coupler of the charging dispenser by using one or more of a mechanical locking mechanism or an electromagnetic locking mechanism. When the adapter is coupled to the cable coupler, a user may use the charging dispenser, once the adapter is decoupled from the holster at step 414, by coupling the adapter to a receiving port that is compatible with the second charging standard. Once the adapter is coupled to the cable coupler, the dispenser controller then causes the first lock latch to unlock to decouple the adapter from the holster, at step 414.

At step 414, the dispenser controller causes the first lock latch to unlock to decouple the adapter from the holster of the charging dispenser. The dispenser controller is configured to communicate a control signal, on the control signal bus, to the first lock latch indicating that the first lock latch unlocks such that the adapter may be removed from the holster for a user to charge a device using the second charging standard. In some implementations the first lock latch unlocks to decouple the adapter from the holster of the charging dispenser by using one or more of a mechanical locking mechanism or an electromagnetic locking mechanism. The charging dispenser may then provide, by the cable coupler and adapter, power using the second charging standard, at step 416.

At step 416, the charging dispenser provides, by the cable coupler, power using the second charging standard with the adapter. The charging dispenser may provide power by the cable coupler and adapter until the power provisioning is terminated by user input or any suitable control signal received from the device being charged. For example, when the device being charged has reached a certain battery charge, the device may communicate a control signal to terminate the power provided from the charging dispenser. In some embodiments, the power provided by the charging dispenser is DC power using the second charging standard (e.g., CCS).

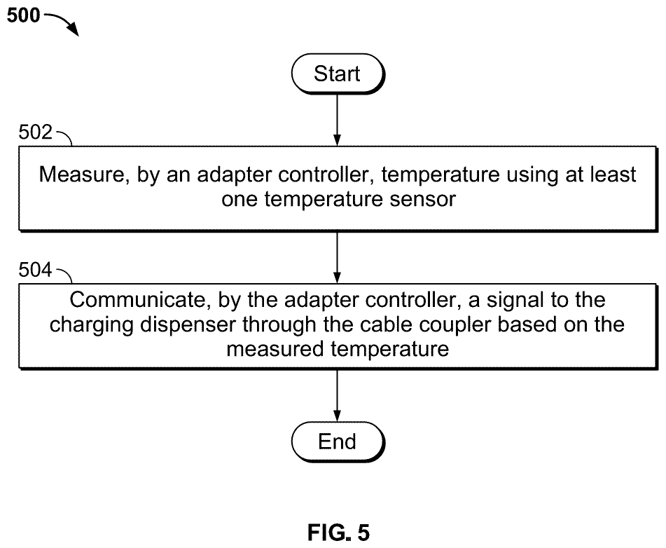

FIG. 5 shows an illustrative flowchart depicting a process 500 for an adapter controller of the adapter to monitor temperature and communicate with the charging dispenser through the cable coupler, in accordance with an embodiment of the present disclosure. In some embodiments, process 500 is executed on adapter by using dispenser controller 104. In some embodiments, referenced charging dispenser, dispenser controller, adapter, holster, first lock latch, charge cable, cable coupler, control signal bus, local interconnect network (LIN), adapter controller, second lock latch, temperature sensor, and temperature signal bus may be implemented as charging dispenser 102, dispenser controller 104, adapter 106, holster 108, first lock latch 110, charge cable 112, cable coupler 114, control signal bus 116, local interconnect network (LIN) 118, adapter controller 302, second lock latch 202, temperature sensor 304, and temperature signal bus 306.

At step 502, the adapter controller measures temperature using at least one temperature sensor. The temperature sensor included in the adapter is communicatively coupled to the adapter controller by the temperature signal bus. In some embodiments, the adapter controller sends a temperature request signal (e.g., polling signal) to each of the temperature sensors for the temperature sensors to measure a respective temperature value and communicate, to the adapter controller, a respective temperature signal with the respective temperature value. In some embodiments, the temperature sensors communicate, to the adapter controller, a respective temperature signal with a respective measured temperature value based on a periodic cycle. In some implementations, the temperature signal bus may be implemented as a wired communication network bus or a wireless communication network bus.

At step 504, adapter controller communicates a signal to the charging dispenser through the cable coupler based on the measured temperature. The signal communicated by the adapter controller may include data that indicates that the measured temperature within the adapter is outside of normal operational temperatures (i.e., when the adapter is overheating due to charging operations). The dispenser controller of the charging dispenser may receive the signal from the adapter controller and determine to derate the power provided through the charge cable or terminate the charging altogether. For example, the adapter controller may communicate a first signal indicating a first measured temperature within the adapter. In such an example, the dispenser controller may determine that the first measured temperature is greater than a first temperature threshold and based on that determination, cause to derate the charging to a corresponding charging rate (e.g., 90% of the normal charging rate). The adapter controller may then communicate a second signal indicating a second measured temperature within the adapter where the second measured temperature is greater than the first measured temperature. When the dispenser controller receives the second signal, the dispenser controller may determine that the first measured temperature is greater than a second temperature threshold and based on that determination, cause to further derate the charging to a corresponding charging rate (e.g., 75% of the normal charging rate). In another example, the adapter controller may communicate a third signal indicating a third measured temperature within the adapter. The dispenser controller may determine that the third measured temperature is greater than a stopping threshold and based on that determination, cause to terminate the charging of the device. In some implementations, the charging may be terminated by way of an electrical switch and/or thermal switch. In some implementations, the adapter controller may calculate an average temperature by determining an average temperature value based on the measured temperature values of the temperature sensors in the adapter. The adapter controller may then communicate the signal to the charging dispenser through the cable coupler based on the calculated average temperature. The adapter controller may determine a maximum temperature among the measured temperature values from the temperature sensors and communicate the signal to the charging dispenser through the cable coupler based on the determined maximum temperature.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A charging dispenser, comprising:
an adapter;
a first lock latch configured to couple the adapter to a holster;
a cable coupler electrically coupled to the dispenser, wherein the cable coupler is configured to:
provide power using a first charging standard without the adapter; and
provide power using a second charging standard when coupled to the adapter; and
a second lock latch configured to couple the cable coupler to the adapter.

2. The charging dispenser of claim 1, wherein the holster comprises the first lock latch and the cable coupler comprises the second lock latch.

3. The charging dispenser of claim 1, wherein each of the first lock latch and the second lock latches comprises a respective motor to move a respective locking member into one of a locked position or an unlocked position.

4. The charging dispenser of claim 3, further comprising a power supply and wherein the holster is configured to, when the first lock latch is locked, electrically couple the respective motor of the second lock latch to the power supply.

5. The charging dispenser of claim 4, wherein when the first lock latch is unlocked and the adapter is removed from the holster, the power supply is electrically uncoupled from the respective motor of the second lock latch.

6. The charging dispenser of claim 1, further comprising a dispenser controller communicatively coupled to the first lock latch and communicatively coupled to an adapter controller of the adapter through a local interconnect network (LIN), wherein the adapter controller is communicatively coupled to the second lock latch.

7. The charging dispenser of claim 6, wherein the dispenser controller is configured to receive a signal that indicates whether the charging dispenser is to (a) provide power using the first charging standard or (b) provide power using the second charging standard.

8. The charging dispenser of claim 7, wherein when the dispenser controller receives a first signal indicating that the charging dispenser is to provide power using the first charging standard, the dispenser controller is configured to:
cause the first lock latch to lock; and
cause the second lock latch to unlock.

9. The charging dispenser of claim 8, wherein to cause the second lock latch to unlock, the dispenser controller is configured to transmit an unlocking control signal on the LIN to the adapter controller.

10. The charging dispenser of claim 7, wherein when the dispenser controller receives a second signal indicating that the charging dispenser is to provide power using the second charging standard, the dispenser controller is configured to:
cause the first lock latch to unlock; and
cause the second lock latch to lock.

11. The charging dispenser of claim 10, wherein to cause the second lock latch to lock, the dispenser controller is configured to transmit a locking control signal on the LIN to the adapter controller.

12. The charging dispenser of claim 7, further comprising a display having a user interface configured to:
collect user input; and
generate, based on the user input, the signal that indicates whether the charging dispenser is to (a) provide power using the first charging standard or (b) provide power using the second charging standard.

13. The charging dispenser of claim 7, wherein the dispenser controller is further configured to receive the signal that indicates whether the charging dispenser is to (a) provide power using the first charging standard or (b) provide power using the second charging standard from a user device.

14. A charging dispenser, comprising:
a cable coupler electrically coupled to the charging dispenser and configured to provide power using a first charging standard; and
an adapter configured to be coupled to the cable coupler and, when coupled to the cable coupler, provide power using a second charging standard, wherein the adapter comprises:
at least one temperature sensor; and
an adapter controller configured to:
measure temperature from the at least one temperature sensor; and
communicate a signal to the charging dispenser through the cable coupler based on the measured temperature.

15. The charging dispenser of claim 14, wherein the adapter controller is further configured to determine whether at least one measured temperature from the at least one temperature sensor exceeds a first temperature threshold, and wherein to communicate the signal to the charging dispenser through the cable coupler based on the measured temperature the adapter controller is to communicate the signal to the charging dispenser to derate the power provided through the cable coupler based on the at least one measured temperature from the at least one temperature sensor.

16. The charging dispenser of claim 14, wherein the adapter controller is further configured to:
determine whether at least one measured temperature from the at least one temperature sensor exceeds a stopping threshold; and
cause to derate power provided through the cable coupler in response to the determination that at least one measured temperature from the at least one temperature sensor exceeds a stopping threshold.

17. The charging dispenser of claim 14, further comprising a dispenser controller and a local interconnect network (LIN) communicatively coupled to the dispenser controller, the LIN configured to measure voltage of power provided by the charging dispenser.

18. The charging dispenser of claim 17, wherein when the adapter is coupled to the cable coupler, the LIN is communicatively coupled to each of the dispenser controller to the adapter controller.

19. The charging dispenser of claim 17, wherein when the adapter is coupled to the cable coupler, the dispenser controller is further configured to provide power to the adapter controller through the LIN.

20. A method comprising:
determining whether a cable coupler of a charging dispenser is to provide power using a first charging standard or provide power using a second charging standard;
in response to the determining that the cable coupler is to provide power using the first charging standard:
causing a first lock latch to lock to couple an adapter to a holster of the charging dispenser;
causing a second lock latch to unlock to decouple the adapter from the cable coupler, which is electrically coupled to the charging dispenser; and
providing, by the cable coupler, power using the first charging standard without the adapter; and
in response to the determining that the cable coupler is to provide power using the second charging standard:
causing the first lock latch to unlock to decouple the adapter from the holster;
causing the second lock latch to lock to couple the adapter to the cable coupler; and
providing, by the cable coupler, power using the second charging standard with the adapter.
